(19) United States
(12) Patent Application Publication
(10) Pub. No.: US 2009/0205449 A1
(43) Pub. Date: Aug. 20, 2009

(54) STEPLESS UNIDIRECTIONAL ROTATION DEVICE

(76) Inventors: Chun-Lung CHEN, Tucheng City (TW); Yu- Sheng CHEN, Tucheng City (TW); Chien-Lin CHEN, Tucheng City (TW)

Correspondence Address: HDLS Patent & Trademark Services, P.O. BOX 220746, CHANTILLY, VA, 20153-0746, US

(21) Appl. No.: 12/033,343

(22) Filed: Feb. 19, 2008

(51) Int. Cl. F16H 21/12; F16C 19/22

(52) U.S. Cl. 74/63; 384/548

(57) ABSTRACT

A stepless unidirectional rotation device includes a housing, a connecting component, a lower roller bearing, turntable assembly, a switching mechanism, a suppressing component and an upper roller bearing. The housing has a receiving room. The connecting component includes a shaft, and one end of the shaft extends out of the receiving room. The lower roller bearing is disposed in the receiving room and rolling contacts with the housing. The turntable assembly includes a rotating disc and a washer. The rotating disc includes a flat surface and an oblique surface. The switching mechanism is connected with the rotating disc. The suppressing component is disposed in the receiving room and is set around the shaft. The upper roller bearing is sandwiched between the washer and the suppressing component and rolling contacts with the suppressing component. Thus, the self-locking or loose problem can be avoided.

### BACKGROUND

The present invention relates to rotation devices, particularly to a rotation device applied to gears or flywheels.

A conventional stepless rotation device disclosed in Taiwan Patent No. 1281427 includes a base, a first connection element, a second connection element, a switching mechanism, and a rotating disc. The base includes a receiving room and a stopper. The first connection element is disposed in the receiving room, and includes a driven part and a first connection end. The driven part defines a groove. A lantern ring is disposed between the driven part and the first connection end, and a tab of the lantern ring combines with the groove of the driven part. The second connection element is disposed in the receiving room, and includes a disc base and a second connection part. A driving tab extends from the second connection element and combines with the groove of the driven part. The switching mechanism is located in the receiving room, and is arranged above the lantern ring corresponding to the driven part of the first connection element. The switching mechanism includes two reverse switching drivers which turn along reverse angles with each other. The rotating disc is located in the receiving room, and is set around the first connection element, as a result, the rotating disc leans to the stopper. An end face of the rotating disc connects with one of switching drivers. In addition, the rotating disc includes a locking tab combining with the groove of the driven part of the first connection element.

The conventional stepless rotation device can improve the alignment of assembly, the driving performance, the yield rate, and so on. However, in practical application, the conventional stepless rotation device has following defects. The rotating disc is arranged around the first connection element, and is positioned in the receiving room of the base. The opposite sides of the rotating disc are slanted, and the rotating disc combines with an inner wall of the base and the switching mechanism. When the base is rotated, the rotating disc steplessly combines with the inner wall of the base and the switching mechanism. When an oblique angle of the rotating disc is more than 30 degrees, the rotating disc cannot tightly contact with the inner wall of the base and the switch mechanism. Also, when an oblique angle of the rotating disc is less than 15 degrees, the friction force produced between the contacting surfaces thereof is larger than a horizontal force of an actuating force. As a result, a self-locking problem may be caused. Therefore, the conventional rotation device needs to be improved.

### BRIEF SUMMARY

An embodiment of the present invention provides a stepless unidirectional rotation device. In the present rotation device, an oblique surface is formed on a side of a rotating disc, and an angle of the oblique surface is predetermined in a certain range. Thus, a self-locking or loose problem can be avoided.

A stepless unidirectional rotation device includes a housing, a connecting component, a lower roller bearing, turntable assembly, a switching mechanism, a suppressing component and an upper roller bearing. The housing has a receiving room. The connecting component includes a shaft. One end of the shaft extends out of the receiving room. The lower roller bearing is disposed in the receiving room and is set around the shaft. The lower roller bearing is configured for rolling contacting with the housing. The turntable assembly is disposed in the receiving room and is set around the shaft. The turntable assembly includes a rotating disc capable of rotating around the shaft, and a washer formed above the rotating disc and capable of moving together with the shaft. The rotating disc includes a flat surface and an oblique surface for combining with the washer. The switching mechanism is disposed at a side of the rotating disc and is connected with the rotating disc. The suppressing component is disposed in the receiving room and is set around the shaft. The suppressing component is capable of rotating relative to the shaft. The upper roller bearing is sandwiched between the washer and the suppressing component. The upper roller bearing is configured for rolling contacting with the suppressing component.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an isometric, exploded view of a preferred embodiment of the present invention;

FIG. 2 is an apparent assembled view of FIG. 1;

FIG. 3 is a sectional assembled view of the preferred embodiment of the present invention;

FIG. 4A and FIG. 4B are respectively a lateral view and a backside view of the preferred embodiment of the present invention;

FIG. 5 is an apparent assembled view of the preferred embodiment of the present invention assembled with a gear;

FIG. 6 is an assembled platform view of the preferred embodiment of the present invention;

FIG. 7 is a lateral view of FIG. 6;

FIG. 8 is similar to FIG. 6, but shown the switch mechanism at an right excursion; and

FIG. 9 is a lateral view of FIG. 8.

### DETAILED DESCRIPTION

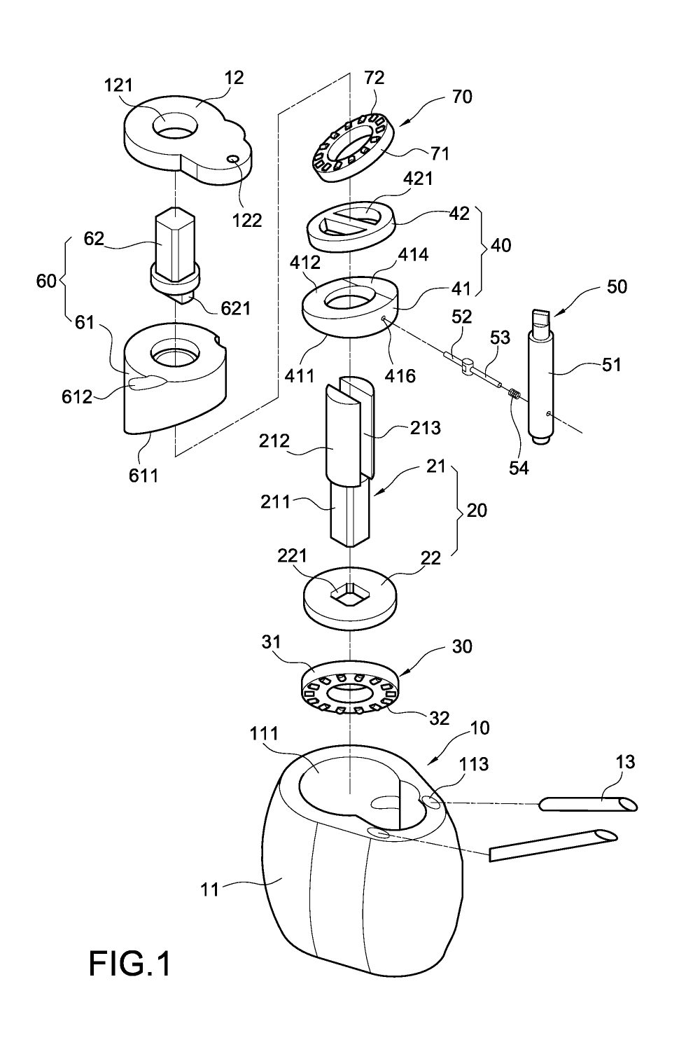

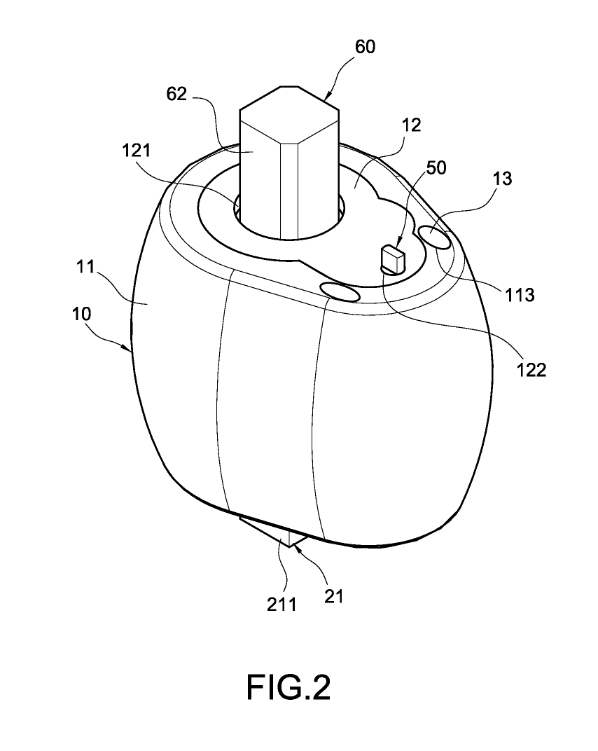

Referring also to FIG. 1 to FIG. 4A and FIG. 4B, a stepless unidirectional rotation device is provided in a preferred embodiment of the present invention. The rotation device includes a housing 10, a connecting component 20, a lower roller bearing 30, a turntable assembly 40, a switching mechanism 50, a suppressing component 60 and an upper roller bearing 70.

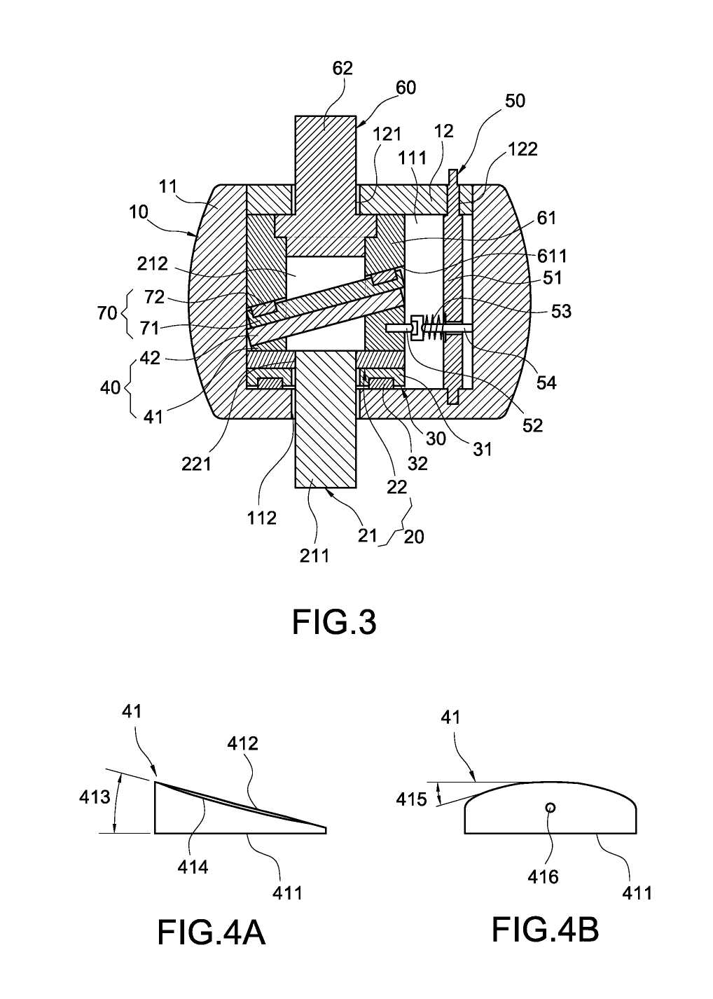

The housing 10 includes a body 11 and a cover 12. In the preferred embodiment of the present invention, the body 11 is formed by two semi-tubby bodies with different internal diameters. A receiving room 111 is defined in the body 11. A through hole 112 is defined in a bottom surface of the receiving room 111 (as shown in FIG. 3). The body 11 defines two sliding holes 113 in a top portion of the body 11 for receiving an inserting pole 13 with each sliding hole 113 therein. The cover 12 is configured for covering on a top portion of the body 11. A large through hole 121 is defined in the cover 12 at the position opposite to the through hole 112 and a small through hole 122 is defined in the cover 12 at one side of the large through hole 121.

The connecting component 20 includes a shaft 21 and a lower washer 22. The shaft 21 includes a square post 211 and a column 212 extending from a top portion of the square post 211. A groove 213 is opened at a center portion of the column 212, and transversely runs through the column 212. A square hole 221 for mating with the square post 211 is defined at a center portion of the lower washer 22. The square post 211 passes through the square hole 221 and the through hole 112 of the housing 10 to arrive at outside of the body 11. In addition, the shaft 21 and the lower washer 22 can be integrally formed (not shown).

The lower roller bearing 30 is disposed in the receiving room 111 and is set around the square post 211 of the shaft 21. The lower roller bearing 30 is sandwiched between the lower washer 22 and a bottom surface of the body 11. The lower roller bearing 30 includes a hollow disc 31 and a number of roller columns 32 connecting with an end surface of the disc 31. A portion of the roller column 32 protrudes from the end surface of the disc 31 for rolling contacting with an inner bottom surface of the body 11 of the housing 10.

The turntable assembly 40 is set around the shaft 21 and is disposed in the receiving room 111 of the body 11. The turntable assembly 40 includes a rotating disc 41 rotating around the shaft 21 and a washer 42 moving together with the shaft 21. The rotating disc 41 is a tapered cylinder, and includes a flat surface 411 combining with the lower washer 22 and an oblique surface 412 formed above the flat surface 411. An angle 413 defined by the flat surface 411 and the oblique surface 412 is about 15 degrees to about 19 degrees. Advantageously, the angle 413 is about 17 degrees. When the angle 413 is larger than 19 degrees, the friction force produced between the contacting surfaces of the rotating disc 41, the washer 42 and the lower washer 22 is less than a horizontal force of an actuating force for driving the rotating disc 41. Thus, the rotating disc 41, the washer 42 and the lower washer 22 prone to loose due to the gravity. When the angle 413 is less than 15 degrees, the friction force produced between the contacting surfaces of the rotating disc 41, the washer 42 and the lower washer 22 is larger than a horizontal force of an actuating force for driving the rotating disc 41, thereby causing self-locking problems. In addition, a side oblique surface 414 is formed at one side of the oblique surface 412, and a side angle 415 is defined by the side oblique surface 414 and the oblique surface 412, as shown in FIG. 4B. The side angle 415 allows the bottom surface of the washer 42 reversely joints to the side oblique surface 414, and functions as a rotating joint surface of the connecting component 20. As a result, the locking phenomena can be avoided between the rotating disc 41 and the washer 42. Furthermore, an inset hole 416 is opened on an outer side wall of the rotating disc 41. The bottom surface of the washer 42 is arranged above the oblique surface 412 of the rotating disc 41. Two openings 421 corresponding to the two columns 212 are defined on the washer 42, thus, each opening 421 mates with the corresponding column 212.

The switching mechanism 50 is arranged behind the turntable assembly 40, and includes a rotating column 51, an inserting pole 52, a T-shaped extension pole 53, and a spring 54. An end of the extension pole 53 is telescopically inserted into a middle portion of the rotating column 51. A top end of the rotating column 51 passes through the small through hole 122 of the cover. An end of the inserting pole 52 and a head portion of the extension pole 53 pivot with each other. Another end of the inserting pole 52 inserts in the inset hole 416 of the rotating disc 41. The spring 54 is set around an outside of the extension pole 53 and is disposed between the head portion of the extension pole 53 and the rotating column 51.

The suppressing component 60 is disposed in the receiving room 111. In the preferred embodiment of the invention, the suppressing component 60 includes a tubular column 61 arranged around the column 212, and an upright post 62 pivotally arranged on the tubular column 61. An oblique surface 611 is formed on a bottom surface of the tubular column 61. The oblique surface 611 is configured for being pressed against the upper roller bearing 70. An angle of the oblique surface 611 is a complementary angle to the angle 413. The oblique surface 611 is pressed tightly against the washer 42 of the rotation assembly 40. A rectangular tab 621 for inserting into the groove 213 protrudes from a bottom end of the upright post 62, thus the upright post 62 rotates together with the shaft 21. The tubular column 61 defines two slots 612 corresponding to the slanted holes 113 for receiving the inserting pole 13. Further, a top portion of the upright 62 transverses through the large through hole 121 of the cover 12.

The upper roller bearing 70 is sandwiched between the washer 42 and the suppressing component 60. The upper roller bearing 70 includes a hollow disc 71 and a number of roller columns 72 connecting with an end surface of the disc 71. A portion of the roller column 32 protrudes from the end surface of the disc 71 for rolling contacting with the oblique surface 611 of the tubular column 61.

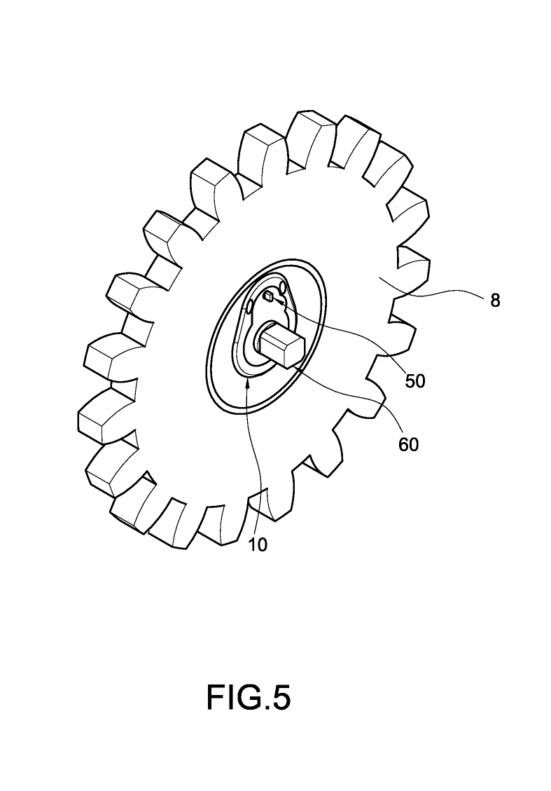

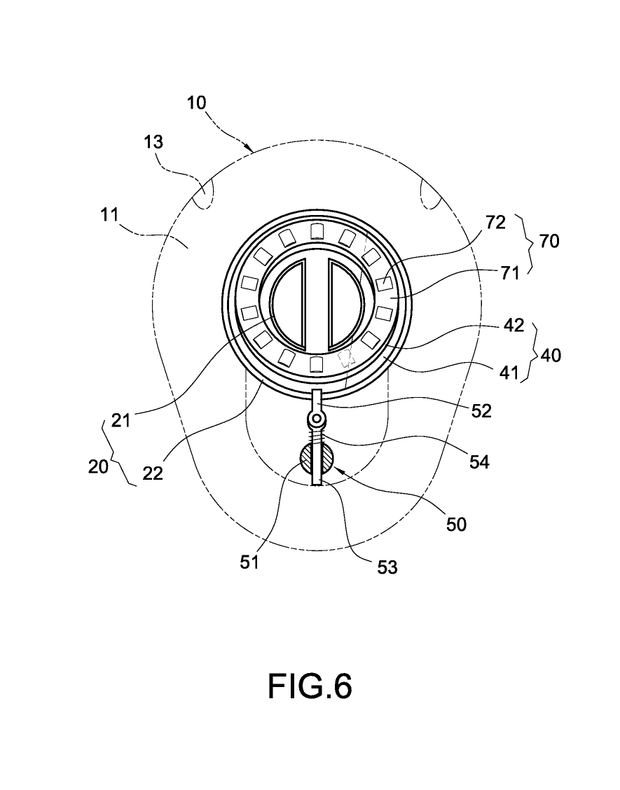

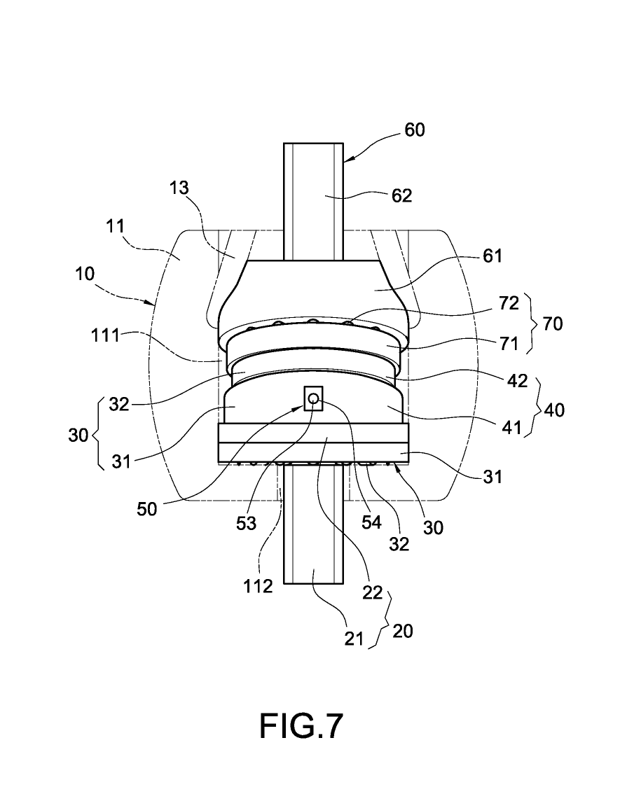

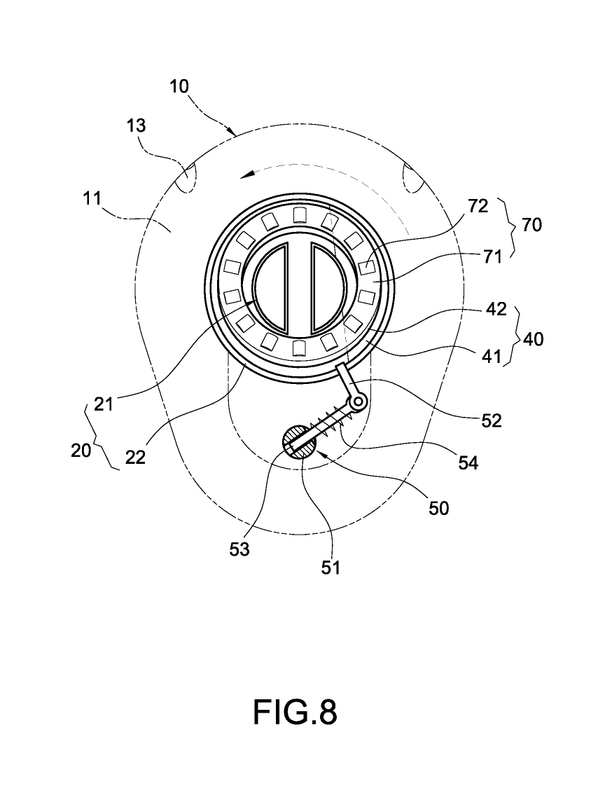

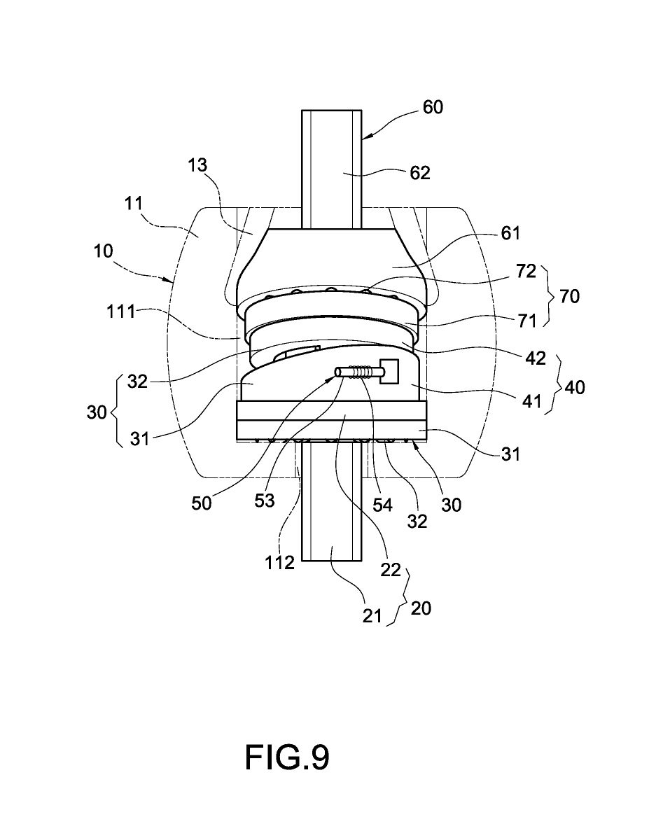

Referring to FIGS. 5-9, the rotation device of the present invention can be applied to a gear 8. In application, the rotating column 51 is rotated in a clockwise direction, the inserting pole 52 with the rotating disc 42 attached is incline to a right side, and the bottom surface of the washer 42 combines with the side oblique surface 414 of the rotating disc 41. When the gear 8 rotates in a counter-clockwise direction, the shaft 21, the lower washer 22, the lower roller bearing 30, the washer 42, upright post 62, and the upper roller bearing 70 acting feed in the counter-clockwise direction relative to the body 11, the rotating disc 41 and the tubular column 61. Contrarily, when the gear 8 rotates in a clockwise direction, the washer 42 is caused to rotate reversely, thereby the washer 42, the lower washer 22 and the rotating disc 41 loose and separate rapidly.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A stepless unidirectional rotation device, comprising:
a housing having a receiving room;
a connecting component comprising a shaft, one end of the shaft being extended out of the receiving room;
a lower roller bearing disposed in the receiving room and set around the shaft, the lower roller bearing being configured for rolling contacting with the housing;
a turntable assembly disposed in the receiving room and set around the shaft, the turntable assembly comprising a rotating disc capable of rotating around the shaft, and a washer formed above the rotating disc and capable of moving together with the shaft, the rotating disc comprising a flat surface and a first oblique surface for combining with the washer;
a switching mechanism disposed at a side of the rotating disc and connected with the rotating disc;
a suppressing component disposed in the receiving room and set around the shaft, the suppressing component being capable of rotating relative to the shaft; and
an upper roller bearing sandwiched between the washer and the suppressing component, the upper roller bearing being configured for rolling contacting with the suppressing component.

2. The rotation device as claimed in claim 1, wherein the shaft comprises a square post and a column extending from the square post, the connecting component comprises a lower washer having a square hole for mating with the square post.

3. The rotation device as claimed in claim 1, wherein a first angle defined by the flat surface and the first oblique surface is in a range from about 15 degrees to about 19 degrees.

4. The rotation device as claimed in claim 3, wherein the first angle is about 17 degrees.

5. The rotation device as claimed in claim 3, wherein the suppressing component comprises a tubular column arranged around the shaft and capable of rotating relative to the shaft, and an upright post inserted into the shaft and capable of moving together with the shaft.

6. The rotation device as claimed in claim 5, wherein a second oblique surface is formed on a bottom surface of the tubular column, and a second angle of the second oblique surface is a complementary angle to the first angle, and the second oblique surface is configured for being pressed against the upper roller bearing.

7. The rotation device as claimed in claim 1, wherein the lower roller bearing comprises a hollow disc and a plurality of roller columns connecting with an end surface of the hollow disc, a portion of the roller column protrudes from the end surface of the hollow disc for rolling contacting with the housing.

8. The rotation device as claimed in claim 1, wherein the switching mechanism comprises a rotating column, an inserting pole for inserting into the rotating disc, an extension pole connecting with the inserting pole and capable of telescopically moving relative to the rotating column, and a spring set around outside of the extension pole and disposed between a head portion of the extension pole and the rotating column.

9. The rotation device as claimed in claim 8, wherein the extension pole is a T-shaped extension pole.

10. The rotation device as claimed in claim 1, wherein the upper roller bearing comprises a hollow disc and a plurality of roller columns connecting with an end surface of the hollow disc, and a portion of the roller column protrudes from the end surface of the hollow disc for rolling contacting with the suppressing component.
